(19) United States
(12) Patent Application Publication
(10) Pub. No.: US 2008/0138776 A1
(43) Pub. Date: Jun. 12, 2008

(54) Educational block set

(76) Inventor: Dianne Zager, New York, NY (US)

Correspondence Address: AMSTER, ROTHSTEIN & EBENSTEIN LLP, 90 PARK AVENUE, NEW YORK, NY, 10016, US

(21) Appl. No.: 11/636,842

(22) Filed: Dec. 11, 2006

(51) Int. Cl. G09B 23/02; G09B 1/00

(52) U.S. Cl. 434/195; 434/208

(57) ABSTRACT

The present invention generally relates to a set of blocks and casings that have various features which provide multi-sensory (e.g., visual, auditory, kinesthetic and tactile) input to the user so as to aid the user in learning mathematics, reading, phonetics, matching and other basic skills. Each block includes a number projections on a first face which are equal in number to recesses on second face. The number of recesses or projections on a particular face block signifies to the user a digit corresponding to that block. Additionally, each block is assigned a color which phonetically cues the user to the number corresponding to the block. Similarly, a casing corresponding in size, shape and color is provided for each block. The casings serve similar functions as the blocks. Preferably, both the casings and the blocks have a textured surface to provide tactile input to the user, thereby encouraging the user to use the blocks and take advantage of its multi-sensory features.

### FIELD OF THE INVENTION

The present invention generally relates to a set of blocks and casings which incorporate multi-sensory features to aid in learning mathematics, reading, matching, phonetics and/or other basic skills.

### BACKGROUND OF THE INVENTION

It is known in the education field that blocks can be used as a visual aid for teaching fundamental principles of mathematics to young children. For example, U.S. Pat. No. 3,094,792 describes a block set in which blocks have various features which aid young children in learning arithmetic. While this prior art provides a useful method for visually teaching mathematics, it does not tap into the other senses which can also aid in learning mathematics, phonetics, reading and other basic skills. For example, in addition to visual aids, young children learn through auditory, kinesthetic and tactile input. This is particularly true for children with learning disabilities, cognitive impairments, sensory impairments and/or communication disorders, and is often true for typically developing pre-school children.

Thus, there has been a long-felt need for a teaching tool which provides multi-sensory input to aid children in learning mathematics, phonetics, reading and other basic skills in a manner that avoids the problems of the prior art.

### SUMMARY OF THE INVENTION

While the prior art block sets are of interest, they present several limitations which the block set and casings of the present invention seek to avoid.

Specifically, it is an object of the present invention to provide an educational block set and casings which provide multi-sensory input, including, visual, auditory, kinesthetic and/or tactile cues, to a user.

It is another object of the present invention to provide a block set and casings which aid in teaching and learning mathematics, reading, and/or phonetics, and also aid in improving perceptual skills, attending skills and/or matching skills.

It is another object to provide a block set and casings which coordinate colors with numbers and/or words.

It is another object to solve the shortcomings of the prior art. Other objects will become apparent from the foregoing description.

It has now been found that the above-related objects are obtained in the form of a block system which comprises: a plurality of blocks, wherein each of the plurality of blocks comprises at least a first face and a second face, a specified number of female connectors on the first face and the same specified number of male connector on the second face, the specified number corresponds to a digit associated with the block, and at least one casing corresponding to each block, and each of the casings corresponds in size and color to the block.

In another embodiment, the block system of the present invention comprises: a plurality of blocks, wherein each of the plurality of blocks has a textured surface and comprises at least a first face and a second face, a specified number of female connectors on the first face and the same specified number of male connector on the second face, and the specified number corresponds to a digit associated with the block.

In yet another embodiment of the present invention, the block system comprises: a plurality of blocks, wherein each of the plurality of blocks comprises at least a first face and a second face, a specified number of female connectors on the first face and the same specified number of male connector on the second face, the specified number corresponds to a digit associated with the block, and each of the plurality of blocks is a different color, wherein the color is associated with the digit in a manner which aids in phonetics and/or reading.

In further embodiments of the present invention, each of the plurality of blocks is a different color, wherein the color is associated with the digit in a manner which aids in reading, phonetics and/or identifying a digit corresponding to the block. Additionally, each block preferably is of a different length proportional to the specified number associated with the block, wherein each length aids in identifying the digit corresponding to each of the blocks. For example, each of the plurality of blocks are preferably of different lengths that are in multiples a specified measure of length, such as one inch.

In another embodiment, at least one of the plurality of blocks has a textured surface, such as textured brush stokes. Moreover, each face of each of the plurality of blocks comprises male or female connectors for connecting to any of the other plurality of blocks.

In another embodiment, each of the casings approximately corresponds in length and/or color to the length and/or color of one of the plurality of the blocks, wherein the length and/or color of the casings aids in identifying the digit, length and/or color of the block to be stored in the casing. Furthermore, at least one of the plurality of casings preferably comprises a soft texture.

From the foregoing, it should be appreciated that the blocks and/or casings of the present invention aid in one or more of the following mathematical skills and operations: number recognition, addition, subtraction, multiplication, division, fractions, measurement, counting, and problem solving. Likewise, the color of each of the plurality of blocks and casings aid in one or more of the following: phonetics, reading, color recognition, size discrimination, matching, visual memory, attending skills, perceptual skills, comprehension, following directions, social skills and other word attack strategies.

### BRIEF DESCRIPTION OF THE DRAWINGS

The above and related objects, features and advantages of the present invention will be more fully understood with reference to the following detailed description of the preferred, albeit illustrative, embodiment(s) of the present invention when considered in conjunction with the accompanying figures, wherein:

FIG. 1 is a perspective view of the blocks of the present invention;

FIG. 2 is a perspective view of casings for the blocks of FIG. 1; and

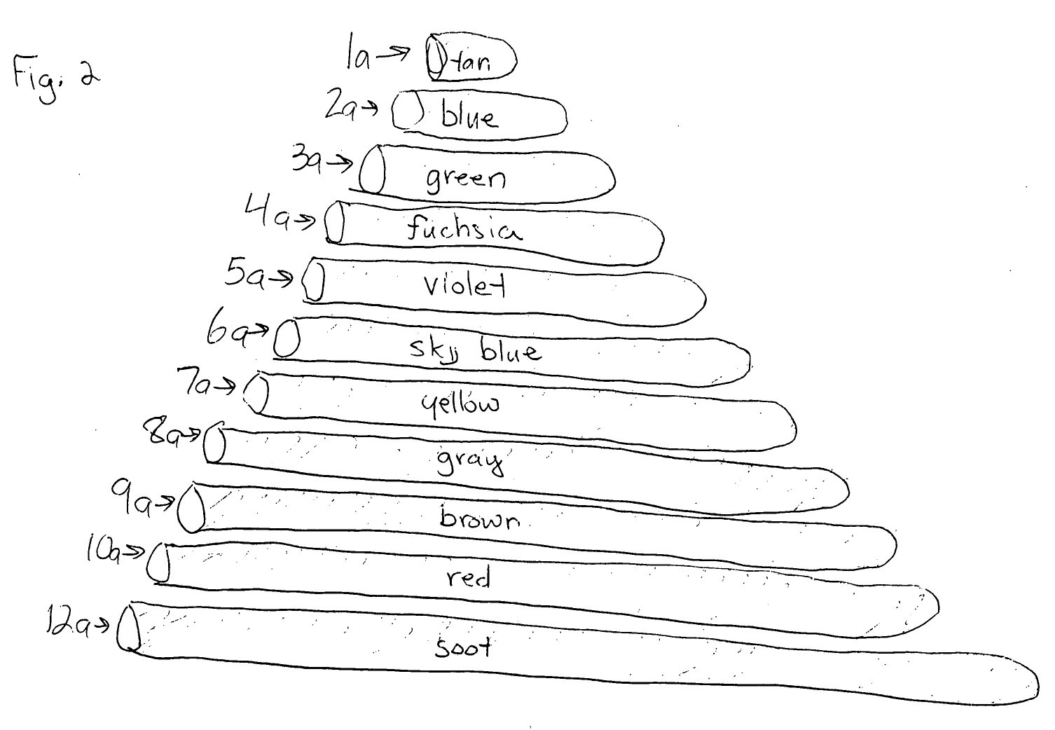

FIG. 3 is a perspective view of a second embodiment of the blocks of the present invention.

### DETAILED DESCRIPTION OF THE PREFERRED EMBODIMENTS

The present invention generally relates to a set of blocks and casings having various features which provide multi-sensory (e.g., visual, auditory, kinesthetic and tactile) input to users in a manner which aids in teaching and learning mathematics, reading, phonetics, matching and other basic skills for young children. The blocks and casings also aid in improving perceptual skills, attending skills and/or matching skills of young children.

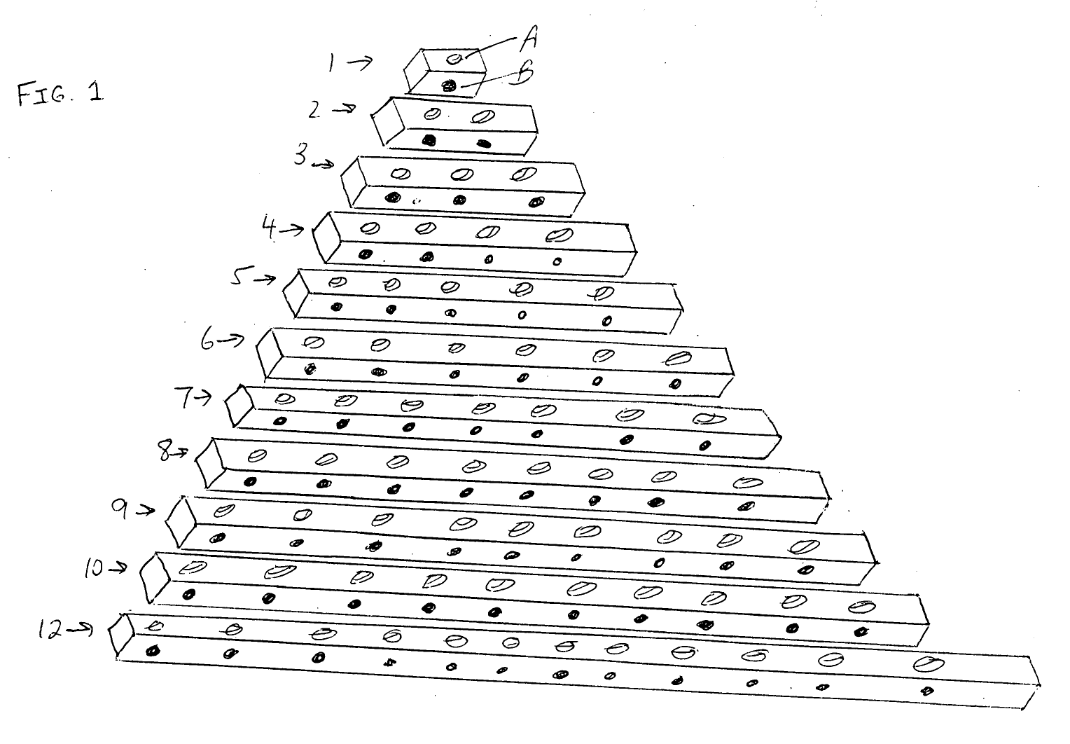

More particularly, referring to FIG. 1, eleven blocks, Blocks 1-10, 12 are shown. Each block has recess(es) A on a first face and like-sized projection(s) B on the second face, as shown and labeled with respect to Block 1. Although not labeled as such in FIG. 1, Blocks 2-10, 12 are shown to have corresponding recesses and projections as well. The recesses and projections serve several functions. First, Blocks 1-10, 12 can be nested on top of one another by mating the recess(es) in one block with the projection(s) in a another block. For example, the recess A of Block 1 mates with one of the projections of Block 2 when these blocks are stacked on each another. The remaining faces of each block can be optionally equipped with the recess(es) and/or the projection(s). The blocks can optionally include one or more projections and recesses (not shown) on their side faces so that one or more blocks can be joined along a horizontal plane.

In addition to mating with one another, the projections and recesses in each Block 1-10, 12 provide visual and tactile cues to the user when teaching and learning mathematics, reading, phonetics and other word attack strategies. More particularly, the number of projections on a particular face of a block equals the number of recesses on an adjacent face of the block. The number of recesses or projections on a particular block signifies to the user a digit corresponding to that block. The recesses and projections on each Blocks 1-10, 12 are preferably equally spaced apart and proportionate to the corresponding digit for that block. For example, since Block 3 includes three equally spaced projections on its first face and three equally spaced recesses on its second face, the digit “3” corresponds to Block 3. Thus, the user can, through visual observation, count the number of recesses or projections on a face of the block to determine the digit that corresponds to the block. The user can also determine the digit by touch (e.g., without visual observation of the recesses and projections). In this regard, the user can count the number of recesses or projections on a particular face by simply running his or her fingers over each recess or projection and counting them as they are touched. Thus, the projections provide both visual and tactile cues to the user in determining the digit corresponding to each Block 1-10, 12.

Moreover, the Blocks 1-10, 12 can be manipulated by the user in such a way that provides visual, tactile and kinesthetic cues to the user in a manner which aids in teaching and learning addition, subtraction, and other mathematical operations. For example, when joining Block 3 (which corresponds to the digit “3”) with Block 1 (which corresponds to the digit “1”) along a horizontal plane, the recesses and projections provide visual and tactile cues to the user which aid with the addition operation of “3+1”. Similarly, by removing Block 1 from Block 3, the same cues are provided to the user to aid with the subtraction operation of “4−1”. Addition and subtraction are merely a few examples of how Blocks 1-10, 12 can be used to teach and learn mathematics, and it is noted that the blocks of the present invention also aid in teaching and learning a host of other mathematical operations, including, but not limited to, number recognition, multiplication, division, fractions, measurements, counting and problem solving.

According to another aspect of this invention, each block is assigned a different color. As discussed below, these colors provide visual and auditory cues to the user in learning mathematics, reading, phonetics and other word attack strategies. More particularly, like the recesses and projections on Blocks 1-10, 12, each color indicates to the user the digit that corresponds to that block. In this regard, colors are assigned to Blocks 1-10, 12 in a manner which cues the user to its corresponding digit. In one embodiment, Blocks 1-10 are assigned the following colors, as set forth in Table 1.

TABLE 1

| Block Number | Color |
|---|---|
| 1 | Tan |
| 2 | Blue |
| 3 | Green |
| 4 | Fuchsia |
| 5 | Violet |
| 6 | Sky Blue |
| 7 | Yellow |
| 8 | Gray |
| 9 | Brown |
| 10 | Red |
| 12 | Soot (brownish-gray) |

According to the embodiment set forth in Table 1, each color provides visual cues the user as to number identification, reading, phonetics and other word attack strategies. For example, the color tan and the number one both have the “n” sound, and thus cues the user to the fact that this color corresponds to the number one for Block 1. Moreover, by pairing this color and number together, the blocks aid the user with phonetics (e.g., pronunciation of both colors and numbers), reading (e.g., color and number recognition) and other word attack strategies. For example, in one embodiment, the ten block is red and each block is referred to as a “fen.” “The ten fen is red” teaches word decoding phonetically by using a linguistic decoding strategy utilizing minimum variation, in that a consonant is placed in front of consistent letter matrices which in this case is en or ed.

The colors of Blocks 2-10, 12 are coordinated in a manner similar to Block 1 to achieve the same purpose. In this regard, since the number two rhymes with blue, this fact cues the user that both this color and number correspond to Block 2. Similarly, cues are provided with respect to Blocks 3, 5, 7, 8 and 10 since: the number three and the color green include the sound “ee”; the number five and the color violet include a long “i” sound; the number seven and the color yellow have the short “e” sound; both the number eight and color gray have the long “a” sound; and the number ten and color red also have the short “e” sound. Moreover, since both the number six and the color sky blue start with the letter “s,” this fact cues the user that this color and number correspond to Block 6. Similarly, since both the number four and the color fuchsia start with the letter “f”, this fact cues the user that this color and number correspond Block 4. Likewise, since both the number nine and the color brown have the “n” sound, this fact cues the user that this color and number correspond to Block 9. Additionally, as discussed below, each block is indicative of a length. Thus, the color “soot”, which rhymes with foot, will cue the user to the fact that Block 12 has a length of one foot.

Thus, by associating each block with a color, visual and auditory cues are provided to the user in teaching and learning various skills, including, but not limiting to number identification, mathematics (e.g., addition, subtraction, counting, etc.), phonetics (e.g., pronouncing both the number and the color), reading (e.g., visually recognizing a color and number), matching and other word attack strategies. Likewise, the Blocks 1-10, 12 also aid in improving perceptual skills, attending skills and/or matching skills of the user.

In one embodiment, each Block 1-10, 12 is of a different length which is proportional to and corresponds to the digit assigned to each block (e.g., the total number of recesses or projections on a particular face). By making this association, visual, tactile and kinesthetic cues are provided to the user to aid in determining lengths of the blocks and measuring other objects. For example, since the number three corresponds to Block 3, the user can determine the length (i.e., three inches) of this block by counting (visually or by touch) the number of recesses or projections on a particular face. Additionally, the user can determine the length of Block 3 by placing it next to blocks of different lengths and noting the differences (e.g., visually or by touch) in the sizes of these blocks. For example, since Block 3 is longer than Blocks 1 and 2 but shorter than Blocks 4-10, 12, the user could note these differences in length by any of the above methodology. As such, these features aid the user in learning and determining measurements of objects.

In one embodiment, each of the Blocks 1-10, 12 is assigned a different length in the manner set forth in Table 2.

TABLE 2

| | |
|---|---|
| Block Number | Length |

| | | |
|---|---|---|
| 1 | 1 | inch |
| 2 | 2 | inches |
| 3 | 3 | inches |
| 4 | 4 | inches |
| 5 | 5 | inches |
| 6 | 6 | inches |
| 7 | 7 | inches |
| 8 | 8 | inches |
| 9 | 9 | inches |
| 10 | 10 | inches |
| 12 | 12 | inches |

Thus, as shown in Table 2, Block 1 correspond to a length of one inch, Block 2 corresponds to a length of two inches, etc. In one embodiment, the Blocks 1-10, 12 are sized to scale (i.e., they are made to the actual length that they correspond to). For example, in this embodiment, Block 12 is twelve inches long, and thus, indicates to the user a measurement for one foot. Moreover, as discussed above, Block 12 can be fuchsia, which color serves as an additional cue that this block has a length of one foot. Thus, the Blocks 1-10, 12 can be used to accurately measure other objects. However, it is not a requirement that each Block 1-10, 12 be the actual length to which it corresponds, provided that each Block 1-10, 12 is of a different length which is proportional to the digit assigned to that block.

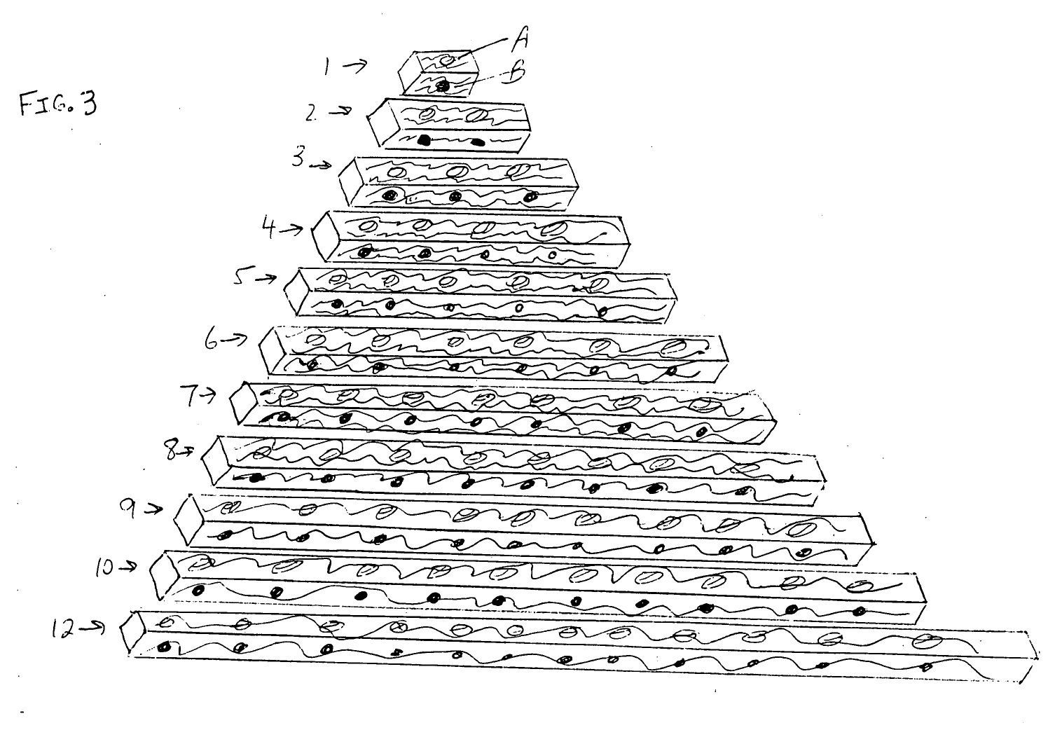

Finally, a separate Casing 1a-10a, 12a for storing each Block 1-10, 12 is provided, as shown in FIG. 3. Each Casing 1a-10a, 12a generally corresponds in size, shape and color to the Block 1-10, 12, which are to be snugly stored therein. As such, the Casings 1a-10a, 12a serve similar functions to the those of Blocks 1-10, 12.

More particularly, the Casings 1a-10a, 12a have a texture which provides tactile input to the user, which in one embodiment is a fuzzy texture. For example, the Casings 1a-10a, 12a may be made of velour-type material (or any other material that feels soft, fuzzy and inviting to the touch) to provide the user with tactile input, which in turn, encourages the user to use the blocks and casings. Moreover, as with each Block 1-10, 12, the length of each Casing 1a-10a, 12a aids the student with number recognition and measurements. For example, Casing 3 is roughly the same size and shape as Block 3. Since Block 3 fits snugly into Casing 3, the user should understand that both the Casing 3 and the Block 3 correspond to the number 3, and that they are both three inches long. Moreover, each Casing 1a-10a, 12a should be assigned the same color as its respective Block 1-10, 12. For example, as shown in Table 3, each block and casing are assigned the same color.

TABLE 3

| Block Number | Case Number | Color |
|---|---|---|
| 1 | 1a | Tan |
| 2 | 2a | Blue |
| 3 | 3a | Green |
| 4 | 4a | Fuchsia |
| 5 | 5a | Violet |
| 6 | 6a | Sky Blue |
| 7 | 7a | Yellow |
| 8 | 8a | Gray |
| 9 | 9a | Brown |
| 10 | 10a | Red |
| 12 | 12a | Soot (brownish-gray) |

Referring to Table 3, since Casing 3 and Block 3 are both green, and thus, have the “ee” sound, these facts cue the user that these items correspond to the digit three.

Accordingly, the coordination of colors between Casings 1a-10a, 12a and Blocks 1-10, 12 aid the user with one or more of the following: reading; color recognition; size discrimination; matching; visual memory; attending skills; comprehension; following directions; perceptual skills, and social skills. Similarly, it should be appreciated that Blocks 1-10, 12 and Casings 1a-10a, 12a are configured in a manner which aids the user with learning variety of different mathematical operations, including, but not limited to, number recognition, addition, subtraction, multiplication, division, fractions, measurements, counting and problem solving.

In another embodiment, one or more of Blocks 1-10, 12 include all of the features of the blocks of FIG. 1, but further include a textured surface on one or more of its faces. In one embodiment, the textured surface can be brush-like, creating an unsmooth, uneven surface. The textured surface provides tactile stimulation and input to the user that facilitates information input through the tactile modality and enhances learning.

It is understood that the presently claimed invention may be embodied in other specified forms without departing from the spirit or central characteristic thereof. The present embodiment should therefore to be considered in all respects as illustrative and not restrictive, and all changes which come within the meaning and range or equivalency of the claims are thereof intended to be embraced therein.

What is claimed is:

1. A block system comprising:
a plurality of blocks, wherein each of said plurality of blocks comprises
at least a first face and a second face,
a specified number of female connectors on the first face and the same specified number of male connector on the second face,
said specified number corresponds to a digit associated with said block, and
at least one casing corresponding to each block, and each of said casings corresponds in size and color to said block.

2. The block system of claim 1, wherein each of said plurality of blocks are of different lengths proportional to the specified number.

3. The block system of claim 2, wherein the length of each of said plurality of blocks aids in identifying said digit corresponding to each of said blocks.

4. The block system of claim 1, wherein each of said blocks are a different color.

5. The block system of claim 4, wherein said color of each of said plurality of blocks aids in identifying said digit corresponding to each of said blocks.

6. The block system of claim 2, wherein each of said casings approximately corresponds in length to the length of one of said plurality of said blocks.

7. The block system of claim 6, wherein the length of each of said casings aids in identifying said digit corresponding to said block having the same length.

8. The block system of claim 7, wherein at least one of said plurality of blocks fits into one of said casings.

9. The block system of claim 4, wherein each casing has a color corresponding to the color of one of said plurality of blocks to be stored in said casing.

10. The block system of claim 9, wherein the color of each of said casings aids in identifying said digit corresponding to at least one of said blocks to be stored in said casing.

11. The block system of claim 1, wherein at least one of said plurality of casings comprises a soft texture.

12. The block system of claim 1, wherein at least one of said plurality of blocks has a textured surface.

13. The block system of claim 12, wherein said textured surface comprises textured brush stokes.

14. The block system of claim 1, wherein one or more of said plurality of blocks aid in one or more of the following mathematical skills and operations: number recognition, addition, subtraction, multiplication, division, fractions, measurement, counting, and problem solving.

15. The block system of claim 4, wherein said color of each of said plurality of blocks aids in one or more of the following: phonetics, reading, color recognition, size discrimination, matching, visual memory, attending skills, perceptual skills, comprehension, following directions, social skills and other word attack strategies.

16. The block system of claim 1, wherein each face of each of said plurality of blocks comprises male or female connectors for connecting to any of said other plurality of blocks.

17. The block system of claim 1, wherein each of said plurality of blocks are of different lengths are in multiples a specified measure of length.

18. The block system of claim 17, wherein said specified measure of length is one inch.

19. A block system comprising:
a plurality of blocks, wherein each of said plurality of blocks has a textured surface and comprises
at least a first face and a second face,
a specified number of female connectors on the first face and the same specified number of male connector on the second face, and
said specified number corresponds to a digit associated with said block.

20. The block system of claim 19, wherein each of said plurality of blocks are of different lengths proportional to the specified number.

21. The block system of claim 20, wherein the length of each of said plurality of blocks aids in identifying said digit corresponding to each of said blocks.

22. The block system of claim 19, wherein each of said blocks are a different color.

23. The block system of claim 22, wherein said color of each of said plurality of blocks aids in identifying said digit corresponding to each of said blocks.

24. The block system of claim 22, further comprising at least one casing corresponding to each block, and each of said casings corresponds in size and color to said block.

25. The block system of claim 24, wherein the size of each of said casings aids in identifying said digit corresponding to said block having the same length.

26. The block system of claim 25, wherein at least one of said plurality of blocks fits into one of said casings.

27. The block system of claim 24, wherein the color of each of said casings aids in identifying said digit corresponding to at least one of said blocks to be stored in said casing.

28. The block system of claim 24, wherein at least one of said plurality of casings comprises a soft texture.

29. The block system of claim 19, wherein at least one of said plurality of blocks has a textured surface.

30. The block system of claim 12, wherein said textured surface comprises textured brush stokes.

31. The block system of claim 29, wherein one or more of said plurality of blocks aid in one or more of the following mathematical skills and operations: number recognition, addition, subtraction, multiplication, division, fractions, measurement, counting, and problem solving.

32. The block system of claim 22, wherein said color of each of said plurality of blocks aids in one or more of the following: phonetics, reading, color recognition, size discrimination, matching, visual memory, attending skills, perceptual skills, comprehension, following directions, social skills and other word attack strategies.

33. The block system of claim 19, wherein each face of each of said plurality of blocks comprises male or female connectors for connecting to any of said other plurality of blocks.

34. The block system of claim 19, wherein each of said plurality of blocks are of different lengths are in multiples a specified measure of length.

35. The block system of claim 34, wherein said specified measure of length is one inch.

36. A block system comprising:
a plurality of blocks, wherein each of said plurality of blocks comprises
at least a first face and a second face,
a specified number of female connectors on the first face and the same specified number of male connector on the second face,
said specified number corresponds to a digit associated with said block, and
each of said plurality of blocks is a different color, wherein said color is associated with said digit in a manner which aids in phonetics.

37. The block system of claim 36, wherein each of said plurality of blocks are of different lengths proportional to the specified number.

38. The block system of claim 37, wherein the length of each of said plurality of blocks aids in identifying said digit corresponding to each of said blocks.

39. The block system of claim 36, wherein said color of each of said plurality of blocks aids in identifying said digit corresponding to each of said blocks.

40. The block system of claim 36, further comprising at least one casing corresponding to each block, and each of said casings corresponds in size and color to said block.

41. The block system of claim 40, wherein the size of each of said casings aids in identifying said digit corresponding to said block having the same length.

42. The block system of claim 40, wherein at least one of said plurality of blocks fits into one of said casings.

43. The block system of claim 40, wherein the color of each of said casings aids in identifying said digit corresponding to at least one of said blocks to be stored in said casing.

44. The block system of claim 40, wherein at least one of said plurality of casings comprises a soft texture.

45. The block system of claim 36, wherein at least one of said plurality of blocks has a textured surface.

46. The block system of claim 45, wherein said textured surface comprises textured brush stokes.

47. The block system of claim 36, wherein one or more of said plurality of blocks aid in one or more of the following mathematical skills and operations: number recognition, addition, subtraction, multiplication, division, fractions, measurement, counting, and problem solving.

48. The block system of claim 36, wherein said color of each of said plurality of blocks aids in one or more of the following: phonetics, reading, color recognition, size discrimination, matching, visual memory, attending skills, perceptual skills, comprehension, following directions, social skills and other word attack strategies.

49. The block system of claim 36, wherein each face of each of said plurality of blocks comprises male or female connectors for connecting to any of said other plurality of blocks.

50. The block system of claim 36, wherein each of said plurality of blocks are of different lengths are in multiples a specified measure of length.

51. The block system of claim 50, wherein said specified measure of length is one inch.

52. A block system comprising:
a plurality of blocks, wherein each of said plurality of blocks comprises
at least a first face and a second face,
a specified number of female connectors on the first face and the same specified number of male connector on the second face,
said specified number corresponds to a digit associated with said block, and
each of said plurality of blocks is a different color, wherein said color is associated with said digit in a manner which aids in reading.

53. The block system of claim 52, wherein each of said plurality of blocks are of different lengths proportional to the specified number.

54. The block system of claim 53, wherein the length of each of said plurality of blocks aids in identifying said digit corresponding to each of said blocks.

55. The block system of claim 52, wherein said color of each of said plurality of blocks aids in identifying said digit corresponding to each of said blocks.

56. The block system of claim 53, further comprising at least one casing corresponding to each block, and each of said casings corresponds in size and color to said block.

57. The block system of claim 56, wherein the size of each of said casings aids in identifying said digit corresponding to said block having the same length.

58. The block system of claim 56, wherein at least one of said plurality of blocks fits into one of said casings.

59. The block system of claim 56, wherein the color of each of said casings aids in identifying said digit corresponding to at least one of said blocks to be stored in said casing.

60. The block system of claim 56, wherein at least one of said plurality of casings comprises a soft texture.

61. The block system of claim 52, wherein at least one of said plurality of blocks has a textured surface.

62. The block system of claim 61, wherein said textured surface comprises textured brush stokes.

63. The block system of claim 52, wherein one or more of said plurality of blocks aid in one or more of the following mathematical skills and operations: number recognition, addition, subtraction, multiplication, division, fractions, measurement, counting, and problem solving.

64. The block system of claim 52, wherein said color of each of said plurality of blocks aids in one or more of the following: phonetics, reading, color recognition, size discrimination, matching, visual memory, attending skills, perceptual skills, comprehension, following directions, social skills and other word attack strategies.

65. The block system of claim 52, wherein each face of each of said plurality of blocks comprises male or female connectors for connecting to any of said other plurality of blocks.

66. The block system of claim 52, wherein each of said plurality of blocks are of different lengths are in multiples a specified measure of length.

67. The block system of claim 66, wherein said specified measure of length is one inch.
